(19) United States
(12) Patent Application Publication
(10) Pub. No.: US 2005/0094200 A1
(43) Pub. Date: May 5, 2005

(54) Image processing apparatus, image processing method, and control program

(75) Inventors: Akihiko Uekusa, Kanagawa (JP); Kenichiro Uotani, Chiba (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/975,352

(22) Filed: Oct. 29, 2004

(30) Foreign Application Priority Data
Oct. 31, 2003 (JP) 2003-372461

(51) Int. Cl. G06F 3/12; G06F 13/00; G06F 9/44

(52) U.S. Cl. 358/1.15; 719/321; 719/328; 710/16

(57) ABSTRACT

An information processing apparatus has: a first obtaining unit for obtaining information showing setting orders of output settings regarding an image process (priority information showing which settings should be preferentially set prior to other settings) and obtaining candidates of output conditions retained in a device driver; and a second obtaining unit for obtaining a predetermined output condition from the candidates of the output conditions obtained by the first obtaining unit by using the information showing the setting orders of the output settings regarding the image process obtained by the first obtaining unit.

### BACKGROUND OF THE INVENTION

1. Field of the Invention

The invention relates to an image processing apparatus and information processing apparatus, method, system, and control program for receiving data from the image processing apparatus and processing it.

2. Related Background Art

Hitherto, in an information processing apparatus including a personal computer or the like in which, for example, an operating system has been implemented, in the case of setting a plurality of print conditions on a print condition setting display screen which an application operating on the operating system for editing a document or an image has before data of an image, a document, or the like edited by the application is formed by a printer driver and printed/outputted by a printing apparatus, the application obtains a list of selection items which can be set on each print condition from the printer driver. Output conditions to be set by the application are obtained in arbitrary order and at arbitrary timing through an API (Application Programming Interface) of the operating system.

Generally, according to the application, when the print condition setting display screen is opened, the list of the selection items which can be set on each print condition is obtained in arbitrary order and the obtained list of the selection items is displayed on the print condition setting display screen, thereby allowing the user to arbitrarily set the desired print conditions.

However, in dependence on the printing apparatus for actually printing/outputting, there is a case where print data cannot be printed/outputted in dependence on a combination of setting contents of a plurality of print conditions. For example, duplex printing or borderless printing cannot be performed on an OHP sheet, or the like, due to a hardware limitation.

In order to cope with competition of such output settings, in the printer driver, there is a technique of discriminating the competition of contents of the output settings inputted to the printer driver through a user interface or properly adjusting the output settings.

### SUMMARY OF THE INVENTION

In such a conventional print system, the application can obtain the list of the selection items which can be set on each output condition and the user can arbitrarily set all combinations of the selection items which can be set on each output condition on an output condition setting display screen which the application has. Therefore, there is such a risk that the user sets illegal print conditions on which the print data cannot be actually printed/outputted, so that a print result which he does not intend is obtained.

Thus, there is considered a possibility that, to avoid such a situation, each developing company of the application and each developing company of an image forming system independently determine the setting order and setting rules of the selection items which can be set by the application and install the application so that the system and the apparatus operate in accordance with the determined setting rules with reference to the priorities of the selection items.

However, functions of image forming apparatuses and printer drivers are frequently improved due to their recent advance and the realization of multifunction of the image forming system. The output setting contents of the applications which can be set are often expanded and changed in association with such improvement.

In such a situation, there is such a problem that if the user conforms with the rules determined uniquely by each company, even in the case of the image data or a print job regarding the same setting contents for obtaining a predetermined output result made by the application, output results differ depending on a type of image forming apparatus or printer driver, so that a correct output result is not obtained.

The invention is made to eliminate at least one of the foregoing problems and it is one aspect of the invention to provide a mechanism for enabling an application to grasp setting order of output setting.

Another aspect of the invention is to provide a mechanism for enabling an application to obtain output setting which can be set at present and setting order of the output setting from a printer driver through an operating system or enabling the application to be notified of the setting order of the output setting from the printer driver.

Further another aspect of the invention is to provide a mechanism for deciding selection items of the output settings which can be set in consideration of setting order of the output setting obtained by an application and preventing illegal output setting which cannot be outputted by the image forming apparatus from being set.

The application comprises a first obtaining unit for obtaining (a) information showing setting orders of output settings regarding an image process (priority information showing which settings should be preferentially set prior to other settings) and obtaining (b) candidates of output conditions retained in a device driver; and a second obtaining unit for obtaining a predetermined output condition from the candidates of the output conditions obtained by the first obtaining unit by using the information showing the setting orders of the output settings regarding the image process obtained by the first obtaining unit.

As another example, there is disclosed an information processing apparatus having a device driver for transmitting and receiving information to/from an application, comprising: managing means for managing output conditions and priorities corresponding to the output conditions; obtaining means for obtaining an output condition inputted through the application; and notifying means for notifying the application of the output condition which is managed by the managing means and has the priority corresponding to the output condition obtained by the obtaining means and the setting orders of the output conditions.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a construction of a print system to which the invention is applied;

FIG. 2 is a block diagram showing a functional construction of the print system;

FIG. 3 is a diagram showing an example of a setting order information table held in a user interface driver;

FIG. 4 is a diagram showing an example of a selection item list information table in borderless printing;

FIG. 5 is a diagram showing an example of a selection item list information table in a type of sheet;

FIG. 6 is a diagram showing an example of a selection item list information table in a sheet size;

FIG. 7 is a diagram showing an example of a print condition setting display screen which is displayed on a display apparatus by an application;

FIG. 8 is a diagram showing an example of a print condition setting display screen in the case where the setting of the borderless printing is “OFF”;

FIG. 9 is a diagram showing an example of a print condition setting display screen in the case where the setting of the sheet type is changed to “postal card”;

FIG. 10 is a diagram showing an example of a print condition setting display screen in the case where the setting of the sheet size is changed to “postcard”;

FIG. 11 is a diagram showing an example of a print condition setting display screen;

FIG. 12 is a diagram showing an example of a print condition setting display screen in the case where the setting of the borderless printing is changed to “ON”;

FIG. 13 is a diagram showing an example of a print condition setting display screen in the case where the setting of the sheet type is changed to “glossy paper”;

FIG. 14 is a diagram showing an example of a print condition setting display screen in the case where the setting of the sheet size is changed to “L(4×6)”;

FIG. 15 is a flowchart for explaining a process for allowing the user interface driver to notify the application of the optimum setting order upon the setting of print conditions;

FIG. 16 is a flowchart for explaining a process for allowing the user interface driver to notify the application of a list of selection items which can be set on the print conditions designated from the application;

FIG. 17 is comprised of FIGS. 17A and 17B showing flowcharts for explaining a process when the application displays the print condition setting display screen onto a display apparatus; and

FIG. 18 is a diagram showing an example of a block structure of various drivers and a GDI (OS) showing transmission and reception of information.

### DETAILED DESCRIPTION OF THE PREFERRED EMBODIMENTS

An embodiment of the invention will be described hereinbelow with reference to the drawings.

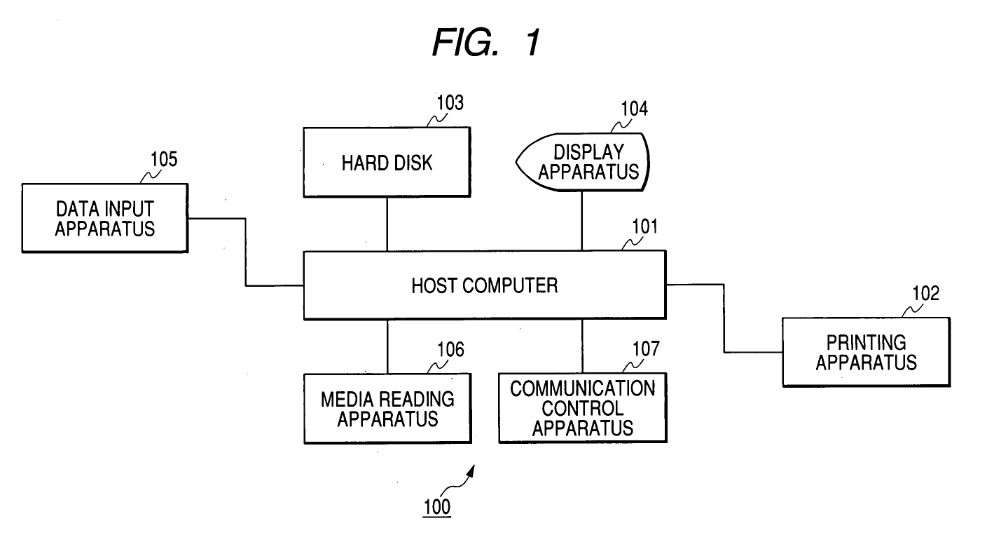

The invention is applied to, for example, a print system 100 as shown in FIG. 1. The print system 100 of the embodiment is constructed in such a manner that when print data of a document, an image, or the like formed by an application that can be activated by a personal computer or the like is printed/outputted onto a sheet by a printing apparatus 102, the print system 100 notifies the application of a list of selection items on a plurality of print conditions which are set on a print condition setting display screen which the application has and are displayed by a display apparatus 104.

A construction and the operation of the print system 100 in the embodiment will now be specifically explained hereinbelow.

<Whole Construction of the Print System 100>As shown in FIG. 1, the print system 100 has a construction in which the printing apparatus 102, a hard disk drive 103, the display apparatus 104, a data input apparatus 105, a media reading apparatus 106, and a communication control apparatus 107 are connected to a host computer 101, respectively.

By executing a predetermined system program, the host computer 101 controls and monitors the whole operation of the print system 100.

Specifically speaking, for example, the host computer 101 has computer functions including a CPU (Central Processing Unit), a RAM (Random Access Memory), a ROM (Read Only Memory), and the like arranged on a system board, which will be explained hereinafter. The CPU properly reads out a desired processing program from a built-in memory, the externally attached hard disk 103, or the like and executes it, thereby controlling the whole operation of the print system 100.

As an example, a storage destination of various programs which are executed by the host computer 101 is assumed to be the hard disk 103 here. A processing program for realizing the operation in the embodiment, various applications for forming print data, and the like have been stored in the hard disk 103.

The storing destination of the processing program (program codes) for realizing the operation in the embodiment is not limited to the hard disk 103 or the built-in memory. For example, it is also possible to construct in such a manner that the processing program is recorded onto a portable recording medium such as CD-ROM, flexible disk, or the like and circulated in such a form that the host computer 101 can read out the processing program, and when the print system 100 is constructed, the host computer 101 reads out the processing program through the media reading apparatus 106 or the communication control apparatus 107 and installs it onto the hard disk 103.

In the embodiment, an OS (Operating System) operates in the host computer 101. When the printing apparatus 102 receives information such as setting contents or the like of the print conditions together with print data from the host computer 101, the printing apparatus 102 executes a predetermined printing process, thereby printing/outputting the print data (forming an image) onto the print sheet.

As a printing apparatus 102, for example, any of various printers such as serial printer, page printer, other electronic-copying type printer, and the like can be applied. Also with respect to a connecting form of the printing apparatus 102 and the host computer 101, for example, any of various connecting forms such as stand-alone connection, network connection, and the like can be applied.

The display apparatus 104 displays a predetermined dialog window in response to an instruction associated with the execution of a system program, the application, or the like. Particularly, the display apparatus 104 displays the print condition setting display screen which the application has in accordance with the instruction from the host computer 101.

The data input apparatus 105 includes a keyboard, a mouse, another pointing device, and the like, receives various instructions from the user, and transfers them to the host computer 101. For example, the data input apparatus 105 notifies the host computer 101 of setting contents of print conditions for the printing apparatus 102 which were inputted from the user. The media reading apparatus 106 includes a CD-ROM drive, a flexible disk (FD) drive, and the like and supplies information read out from a recording medium such as CD-ROM, FD, or the like to the host computer 101.

The communication control apparatus 107 is, for example, a connecting interface for connecting the print system 100 to an external network so that they can communicate with each other.

<Functional Construction of the Print System 100>

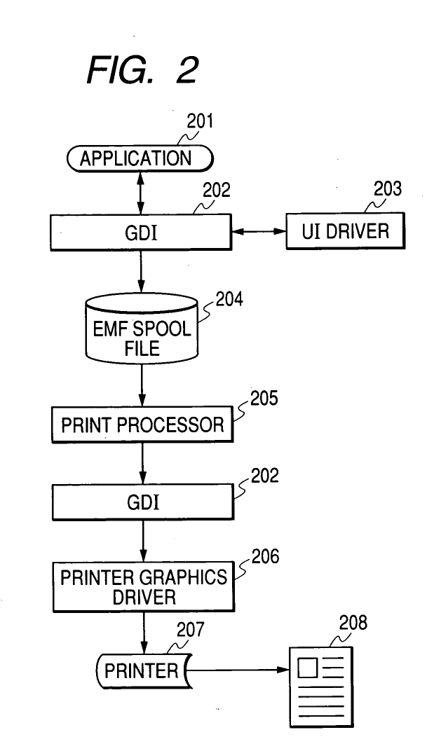

FIG. 2 is a diagram which is obtained by, particularly, paying attention to a print control function among functions of the print system 100 which are realized when the host computer 101 executes a predetermined processing program. As shown in FIG. 2, the print control function by the host computer 101 includes an application 201, a GDI (Graphics Device Interface) 202, a user interface (UI) driver 203, a spool file 204, a print processor 205, and a printer graphics driver 206. First, main functions included in the print control function by the host computer 101 will be described. The application 201 has a function of setting the print conditions to the printing apparatus (printer) 102 through the GDI 202.

Specifically speaking, for example, the application 201 has the functions of setting a size of sheet which is used for printing and other print conditions.

The user interface driver 203 has a function of notifying the application 201 of the optimum setting order upon the setting of the print conditions and a list of selection items which can be set on each of the print conditions through the GDI 202 which is installed preferably as a function of the OS.

The print processor 205 has a function of processing print data stored in the spool file 204 on a page unit basis.

The printer graphics driver 206 has a function of converting the print data into bitmap data that can be printed/outputted by the printing apparatus (printer) 102. A series of operations of the print control function by the host computer 101 will now be described. First, the application 201 forms an arbitrary document in accordance with an operating instruction from the user. Subsequently, the application 201 displays the print condition setting display screen onto the display apparatus 104 and inquires of the user interface driver 203 about the optimum setting order upon the setting of the print conditions through the GDI 202.

When the user interface driver 203 receives the inquiry about the optimum setting order upon the setting of the print conditions, it obtains the optimum setting order upon the setting of the print conditions with reference to a setting order information table which has previously been held in the driver 203 and which will be explained in detail hereinafter and notifies the application 201 of it.

The application 201 notifies of the setting contents of the print conditions set on the print condition setting display screen at present through the GDI 202 in accordance with the notified setting order and the operating instruction from the user and inquires of the user interface driver 203 about the list of the selection items which can be set on each print condition.

When the user interface driver 203 receives the inquiry about the list of the selection items which can be set on the designated print condition from the application 201, it obtains the list of the selection items which can be set on the designated print condition with reference to a selection item list information table which has previously been held every combination of the setting contents of the print conditions whose setting orders are higher than the designated print condition and which will be explained in detail hereinafter and notifies the application 201 of it.

When the application 201 receives the list of the selection items which can be set on each print condition, it updates the contents of the print condition setting display screen and, further, receives an operating instruction from the user. The application 201 notifies the GDI 202 of the setting contents of the print conditions set on the print condition setting display screen and instructs the execution of the printing of the document data (print data) in accordance with the operating instruction from the user.

Thus, the GDI 202 notifies the user interface driver 203 of the setting contents of the print conditions in the printing apparatus (printer) 102 and an event to start the printing.

Subsequently, the application 201 stores the document data (print data) into the EMF spool file 204 through the GDI 202.

At this time, the setting contents of the print condition in the printing apparatus (printer) 102 have previously been stored in the EMF spool file 204 by the user interface driver 203.

The print processor 205 obtains the setting contents of the print conditions and the print data from the EMF spool file 204 and supplies the setting contents of the print conditions and the print data to the printer graphics driver 206 on a page unit basis.

The printer graphics driver 206 forms bitmap data for printing (hereinafter, referred to-as a “print image”) from the print page data supplied from the print processor 205 on the basis of a graphics draw command formed by the GDI 202 and the setting contents of the print conditions previously notified from the print processor 205.

The printer graphics driver 206 supplies the print image to the printing apparatus (printer) 102 through an arbitrary data transmitting unit (not shown).

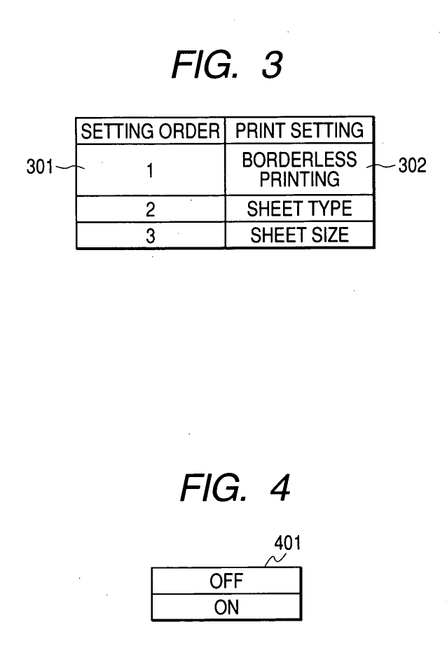

The printer 102 prints/outputs the print image supplied from the printer graphics driver 206 onto a sheet 208. FIG. 3 is a diagram showing an example of the setting order information table held in the user interface driver 203. In FIG. 3, reference numeral 301 denotes optimum setting order upon the setting of the print conditions.

In FIG. 3, reference numeral 302 denotes print conditions as output conditions to be set, decided, and instructed in the order shown at 301 in the optimum setting order upon the setting of the print conditions. For example, the first setting order as an example of the information showing the setting order indicates the borderless printing, the second setting order indicates the sheet type, and subsequently, the third setting order indicates the sheet size. That is, in response to the designation of the output conditions whose setting orders are higher and which are shown in an entry of FIG. 3, the designated setting items of the output conditions whose setting orders are lower are determined. For example, the selection item of the sheet type is decided in accordance with the designation of ON/OFF of the upper borderless printing, the selection item of the sheet size is decided in accordance with the selection of the sheet type.

FIGS. 4 to 6 show examples of the selection item list information table held in the user interface driver 203.

FIG. 4 is a diagram showing the example of the selection item list information table in the borderless printing. In FIG. 4, reference numeral 401 denotes a list of selection items which can be set in the borderless printing as an example of the output conditions. That is, according to FIG. 4, a condition in which ON/OFF can be selected is set as an output condition of the borderless printing.

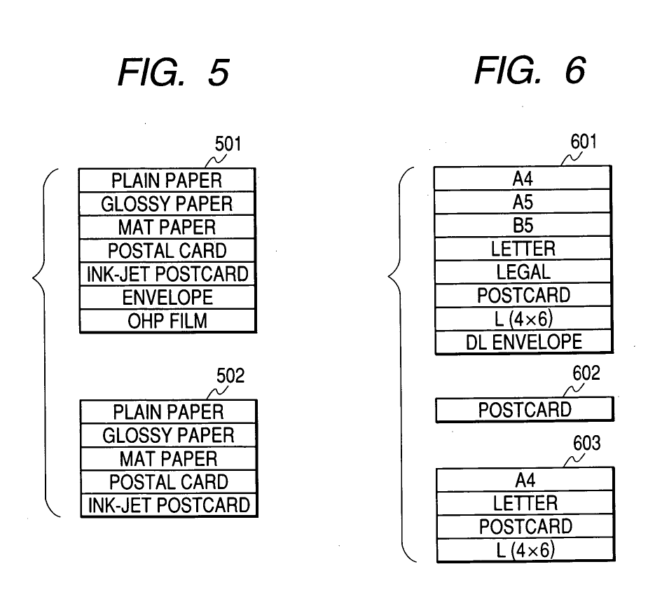

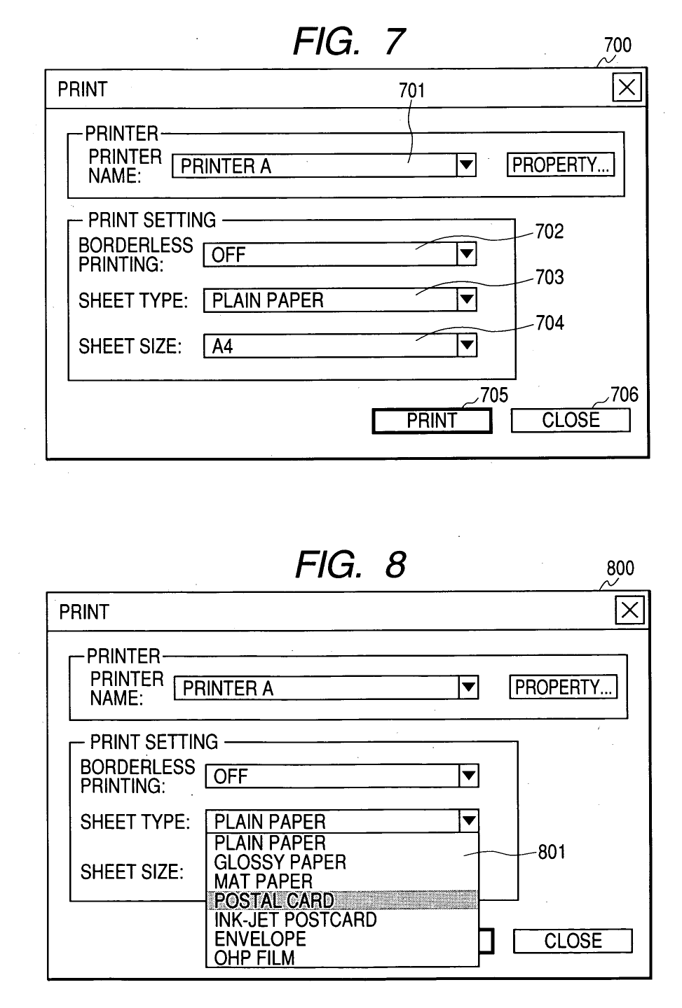

FIG. 5 is a diagram showing the example of a selection item list information table in the type of sheet. In FIG. 5, reference numeral 501 denotes a list of selection items which can be set in the sheet type as an example of the output conditions in the case where the setting of the borderless printing is “OFF” in an item column 702 in FIG. 7 for controlling the process for displaying by the application 201. In FIG. 5, reference numeral 502 denotes a list of selection items which can be set in the sheet type in the case where the setting of the borderless printing is “ON” in 702 in FIG. 7. This information is displayed by inquiring of the application 201 by the user interface driver 203.

FIG. 6 is a diagram showing the example of a selection item list information table in the sheet size. In FIG. 6, reference numeral 601 denotes a list of selection items which can be set in the sheet size in the case where the setting of the borderless printing is “OFF” and the setting of the sheet type is “plain paper” in an item column 703 in FIG. 7. In FIG. 6, reference numeral 602 denotes a list of selection items which can be set in the sheet size in the case where the setting of the borderless printing is “OFF” and the setting of the sheet type is “postal card” in 703 in FIG. 7 for controlling the process for displaying by the application 201. Therefore, when the setting of the borderless printing is “OFF” and the setting of the sheet type is “postal card” in FIG. 7, only “postcard” can be selected as a sheet size. Thus, the user can properly and easily set the selection item prior to printing.

In FIG. 6, reference numeral 603 denotes a list of selection items which can be set in the sheet size as an example of the output conditions in the case where the setting of the borderless printing is “ON” and the setting of the sheet type is “glossy paper”.

<Print Condition Setting Display Screen which the Application has>

FIG. 7 is a diagram showing an example of a print condition setting display screen 700 which is displayed on the display apparatus 104 by the application 201. In FIG. 7, reference numeral 701 denotes an item column for allowing the user to select the printing apparatus (printer) to print the print data. In FIG. 7, reference numeral 702 denotes the item column for allowing the user to select whether or not the print data is printed/outputted so that no border is caused on the sheet.

In FIG. 7, reference numeral 703 denotes the item column for allowing the user to select the type of sheet onto which the print data is printed/outputted. In FIG. 7, reference numeral 704 denotes an item column for allowing the user to select the size of sheet onto which the print data is printed/outputted. In FIG. 7, reference numeral 705 denotes an item column for notifying the GDI 202 of the setting contents of the print conditions set on the print condition setting display screen, instructing the execution of the printing of the print data, and thereafter, closing the print condition setting display screen.

In FIG. 7, reference numeral 706 denotes an item column for closing the print condition setting display screen without instructing the execution of the printing of the print data. FIGS. 8 to 10 show examples of print condition setting display screens 800 to 1000 which are displayed on the display apparatus 104 in the case where on the print condition setting display screen which is displayed on the display apparatus 104 by the application 201, a procedure to change the settings from the states shown on the print condition setting display screen 700 in FIG. 7 to the borderless printing “OFF”, the sheet type “postal card”, and the sheet size “postcard” is executed.

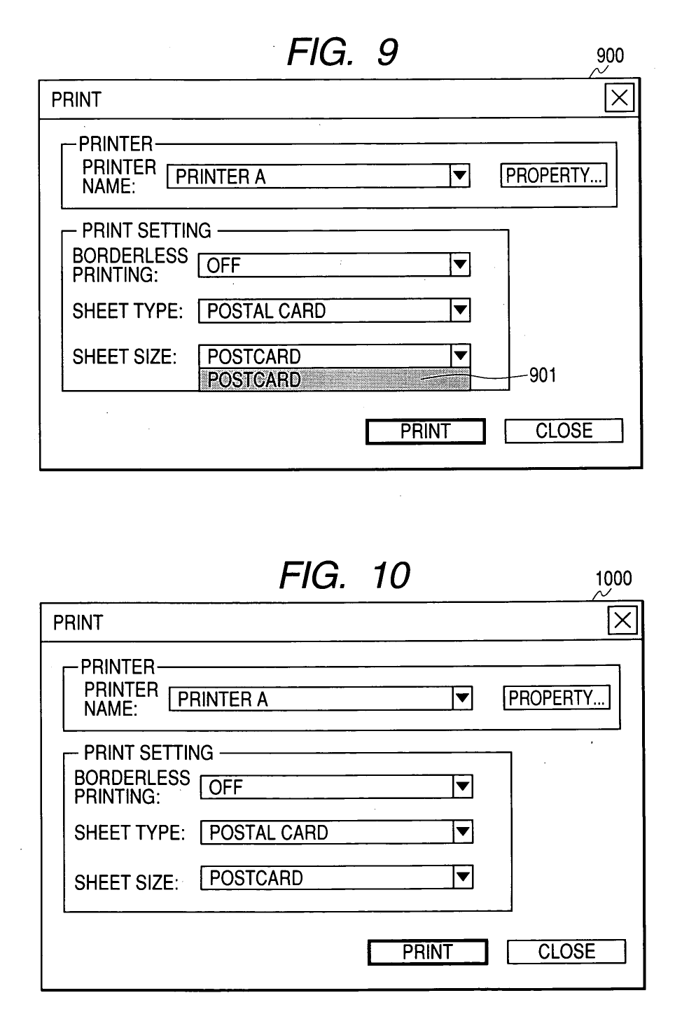

FIG. 8 is a diagram showing an example of the print condition setting display screen 800 in the case where the setting of the borderless printing is “OFF”. In FIG. 8, reference numeral 801 denotes a list of selection items which can be set in the sheet type in the case where the setting of the borderless printing is “OFF”. FIG. 9 is a diagram showing an example of the print condition setting display screen 900 in the case where the setting of the sheet type is changed to “postal card” in 801 in FIG. 8.

In FIG. 9, reference numeral 901 denotes a list of the selection items which can be set in the sheet size in the case where the setting of the borderless printing is “OFF” and the setting of the sheet type is “postal card”. FIG. 10 is a diagram showing an example of the print condition setting display screen 1000 in the case where the setting of the sheet size is changed to “postcard” in 901 in FIG. 9.

The specific operation will now be described. When the borderless printing “OFF” is selected in the application 201 in FIG. 7, the application 201 obtains the information stored in the tables in FIG. 5 held in the user interface driver 203 through the GDI 202. For example, in response to the designation of the borderless printing “OFF” in 702 in FIG. 7, the application 201 receives the information stored in the tables in FIG. 5 from the user interface driver through the GDI 202, selects the selection item list shown in 501 in FIG. 5, and displays those items so that they can be selected as shown in 801 in FIG. 8, or it is also possible to construct in such a manner that the application notifies the user interface driver that the borderless printing “OFF” was designated and requests the user interface driver to obtain and return the data in 501 corresponding to “OFF” in FIG. 5. When the borderless printing “ON” is designated in 702 in FIG. 7, the application similarly communicates with the user interface driver and displays the values stored in the table 502 in FIG. 5 (not shown).

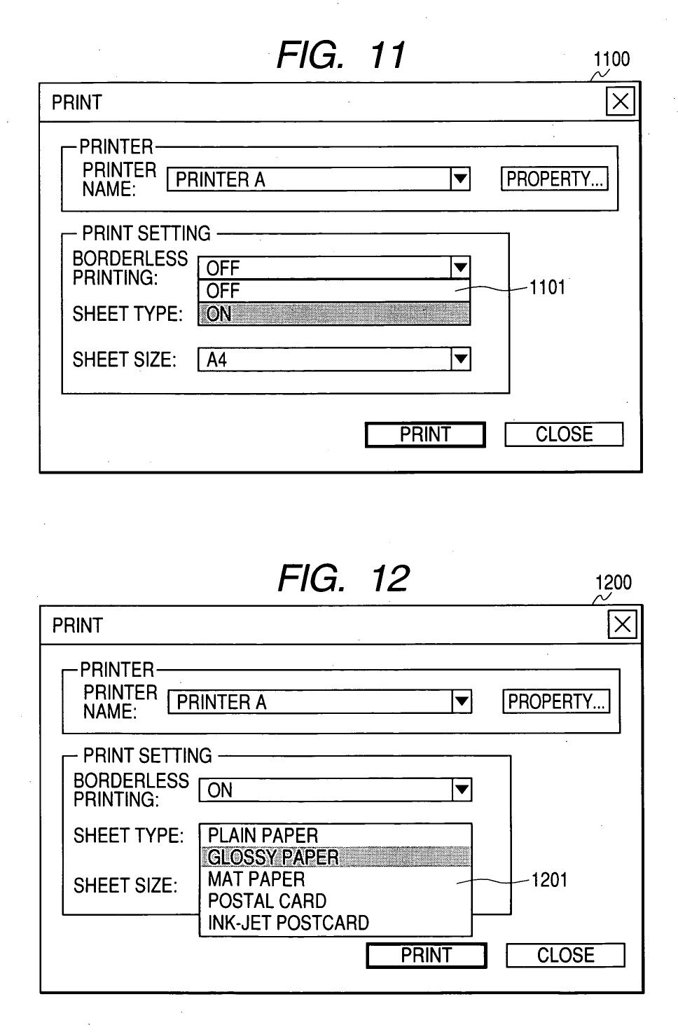

FIGS. 11 to 14 show examples of print condition setting display screens 1100 to 1400 which are displayed on the display apparatus 104 in the case where on the print condition setting display screen which is displayed on the display apparatus 104 by the application 201, a procedure to change the settings from the state shown on the print condition setting display screen 700 in FIG. 7 to the borderless printing “ON”, the sheet type “glossy paper”, and the sheet size “L(4×6)” is executed.

FIG. 11 is a diagram showing the example of the print condition setting display screen 1100. In FIG. 11, reference numeral 1101 denotes a list of selection items which can be set in the borderless printing. FIG. 12 is a diagram showing the example of the print condition setting display screen 1200 in the case where the setting of the borderless printing is changed to “ON” in 1101 in FIG. 11. In FIG. 12, reference numeral 1201 denotes a list of selection items which can be set in the sheet type in the case where the setting of the borderless printing is “ON”.

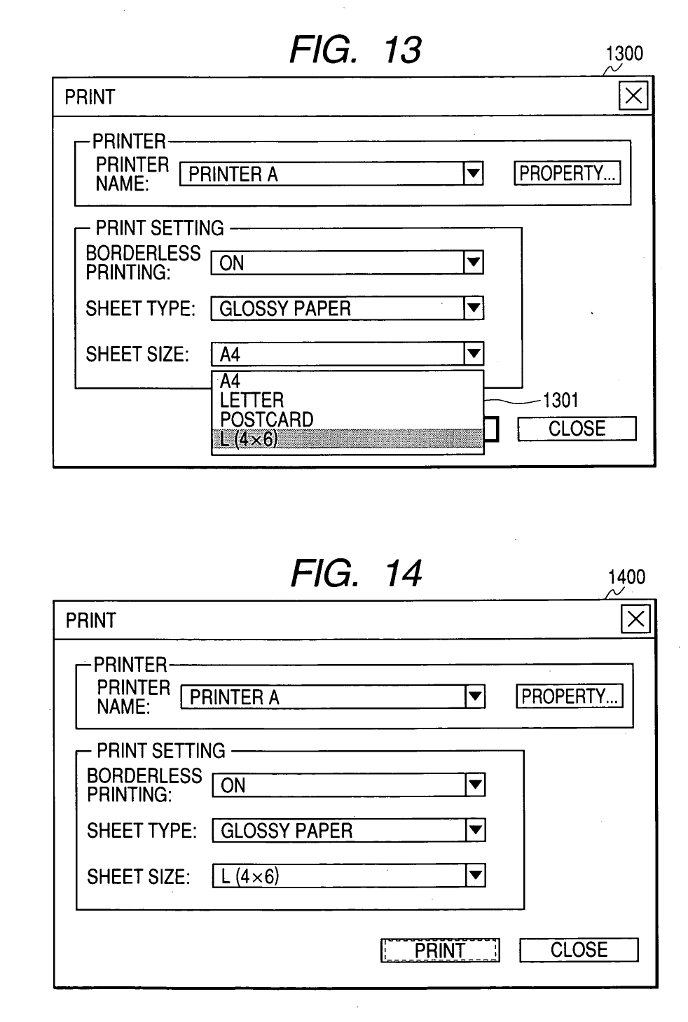

FIG. 13 is a diagram showing the example of the print condition setting display screen 1300 in the case where the setting of the sheet type is changed to “glossy paper” in 1201 in FIG. 12.

In FIG. 13, reference numeral 1301 denotes a list of selection items which can be set in the sheet size in the case where the setting of the borderless printing is “ON” and the setting of the sheet type is “glossy paper”.

FIG. 14 is a diagram showing the example of the print condition setting display screen 1400 in the case where the setting of the sheet size is changed to “L(4×6)” in 1301 in FIG. 13.

<Operation of the Print System 100>

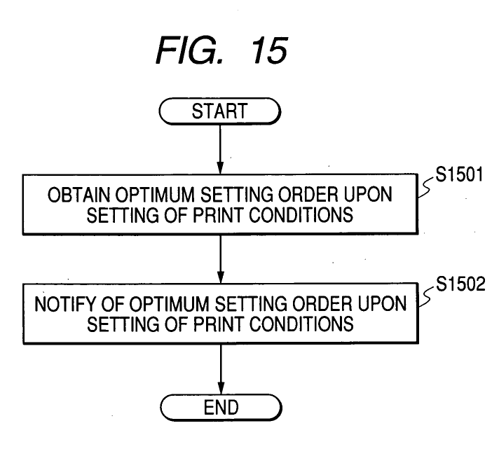

FIG. 15 is a flowchart showing a process for allowing the user interface driver 203 to notify the application 201 of the optimum setting order upon the setting of the print conditions as an operation of the print system 100.

Step S1501:

The user interface driver 203 obtains the optimum setting order upon the setting of the print conditions from the setting order information table shown in FIG. 3. In step S1502, the user interface driver 203 notifies the application 201 of the optimum setting order upon the setting of the print conditions obtained in step S1501 and finishes the processing routine.

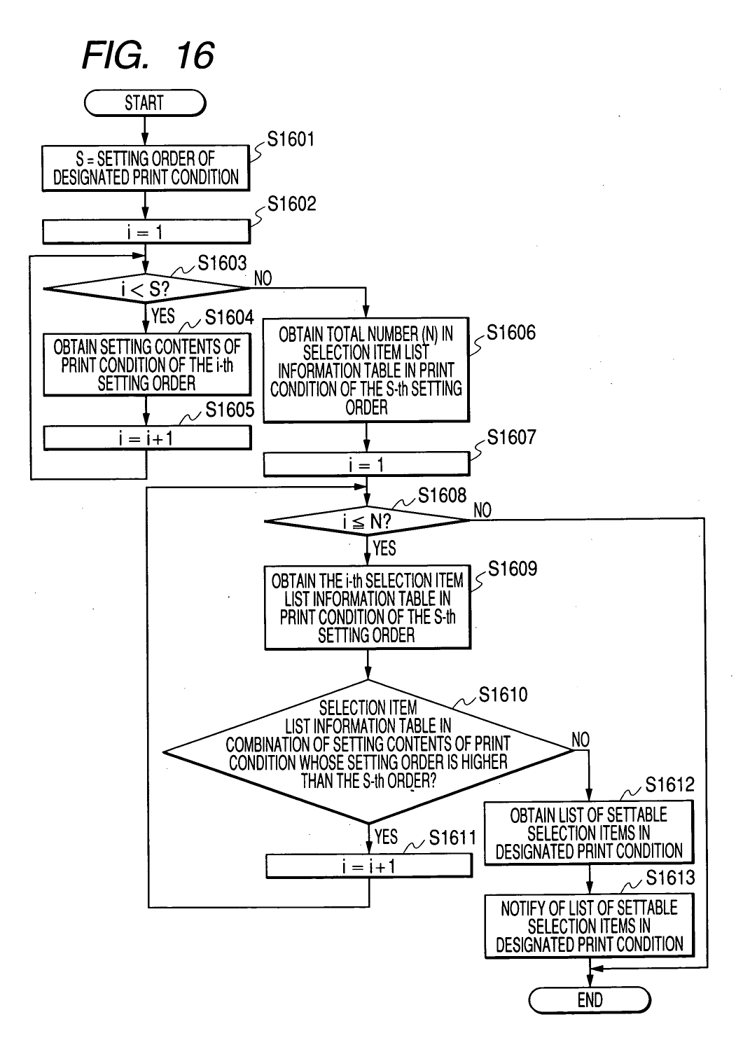

FIG. 16 is a flowchart showing a process for allowing the user interface driver 203 to determine the list of the selection items which can be set on the print conditions designated from the application 201 and notify the application 201 of the list as an operation of the print system 100.

In step S1601, the user interface driver 203 obtains the setting order of the print conditions designated from the application 201 with reference to the setting order information table shown in FIG. 3.

In step S1602, a count value (i) of a processing counter is initialized to “1” in order to obtain the setting contents of the print conditions whose setting orders are higher than the print conditions designated from the application 201 in steps S1603 to S1605 by repeating the processes as many times as the number of print conditions whose setting orders are higher than the print conditions designated from the application 201.

In step S1603, the user interface driver 203 discriminates whether or not the count value (i) of the processing counter exceeds the number (S-1) of print conditions whose setting orders are higher than the print conditions designated from the application 201. If the count value exceeds the number (S-1) of print conditions whose setting orders are higher than the print conditions designated from the application 201 as a result of the discrimination, the processing routine advances to step S1606. If NO, step S1604 follows.

In step S1604, the user interface driver 203 obtains the setting contents of the print conditions whose setting orders (priorities) are the same as the count value (i) of the processing counter with reference to the setting contents of the print conditions which have been notified from the application 201 and set on the print condition setting display screen at present.

In step S1605, the user interface driver 203 increases the value of the processing counter by “1” and returns to step S1603.

In step S1606, the user interface driver 203 obtains the total number (N) of selection item list information tables on the print conditions as an example of the output conditions designated from the application 201 among the selection item list information tables on the output conditions shown in FIGS. 4 to 6.

In step S1607, the value of the processing counter is initialized to “1” in order to search the selection item list information tables in a combination of the setting contents of the print conditions obtained in step S1603 from the selection item list information tables on the print conditions designated from the application 201 among the selection item list information tables shown in FIGS. 4 to 6 in steps S1608 to S1611.

In step S1608, the user interface driver 203 discriminates whether or not the count value (i) of the processing counter exceeds the total number (N) of selection item list information tables obtained in step S1606. If the count value (i) exceeds the total number (N) of selection item list information tables obtained in step S1606 as a result of the discrimination, the processing routine is finished. If NO, step S1609 follows.

In step S1609, the user interface driver 203 obtains the selection item list information table whose setting order is the same as the count value of the processing counter from the selection item list information tables on the print conditions designated from the application 201 among the selection item list information tables shown in FIGS. 4 to 6.

In step S1610, the user interface driver 203 discriminates whether or not the selection item list information table obtained in step S1609 is the selection item list information table in the combination of the setting contents of the print conditions obtained in step S1603. If it is the selection item list information table in the combination of the setting contents of the print conditions obtained in step S1603 as a result of the discrimination, step S1612 follows. If NO, step S1611 follows.

In step S1611, the user interface driver 203 increases the value of the processing counter by “1” and returns to step S1608.

In step S1612, the user interface driver 203 obtains the list of the selection items which can be selected on the print conditions designated from the application 201 with reference to the selection item list information table obtained in step S1609.

In step S1613, the user interface driver 203 notifies the application 201 of the list of the selection items (obtained in step S1612) which can be selected on the print conditions designated from the application 201 and finishes the processing routine.

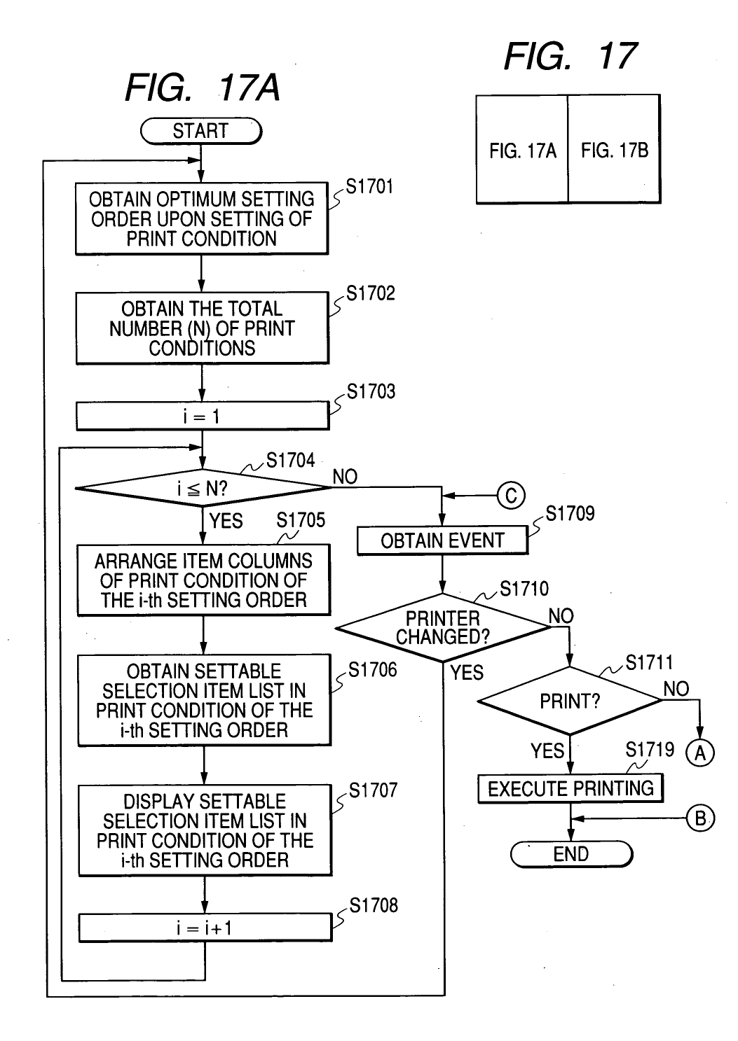

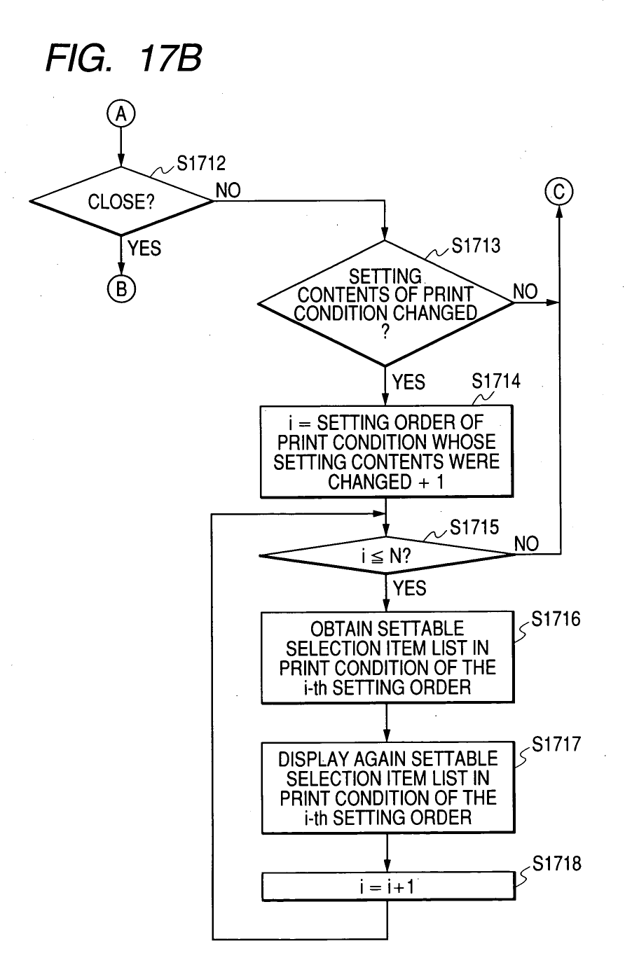

FIGS. 17A and 17B are flowcharts showing a process when the print condition setting display screen 700 is displayed on the display apparatus 104 by the execution of the application 201.

In step S1701, the application 201 obtains the optimum setting order upon the setting of the print conditions from the user interface driver 203 through the GDI 202 and advances to step S1702. In step S1702, the application 201 obtains the total number (N) of print conditions which are set on the print condition setting display screen 700 with reference to the optimum setting order upon the setting of the print conditions obtained in step S1701. In step S1703, the count value (i) of the processing counter is initialized to “1” in order to perform the initial display of the print condition setting display screen 700 in steps S1704 to S1708 by repeating the processes as many times as the total number (N) of print conditions which are set on the print condition setting display screen 700 obtained in step S1702.

In step S1704, the application 201 discriminates whether or not the count value (i) of the processing counter exceeds the total number (N) of print conditions which are set on the print condition setting display screen 700. If it exceeds the total number of print conditions which are set on the print condition setting display screen 700 as a result of the discrimination, step S1709 follows. If it does not exceed the total number, step S1705 follows.

In step S1705, the application 201 arranges the item columns of the print condition whose setting order is the same as the count value of the processing counter onto the print condition setting display screen 700 with reference to the optimum setting order upon the setting of the print conditions obtained in step S1701.

In step S1706, the application 201 obtains the list of the selection items which can be set on the print condition whose setting order is the same as the count value of the processing counter from the user interface driver 203 with reference to the optimum setting order upon the setting of the print conditions obtained in step S1701.

In step S1707, the application 201 displays the list of the settable selection items obtained in step S1706 into the item columns arranged in step S1705.

In step S1708, the application 201 increases the count value of the processing counter by “1” and returns to step S1704.

In step S1709, the application 201 obtains the event when it receives the operating instruction from the user on the print condition setting display screen 700.

In step S1710, the application 201 discriminates whether or not the printer has been changed on the basis of the event obtained in step S1709. If the printer has been changed as a result of the discrimination, the processing routine is returned to step S1701. If NO, step S1711 follows.

In step S1711, the application 201 discriminates whether or not the item column 705 in FIG. 7 has been selected on the basis of the event obtained in step S1709. If the item column 705 in FIG. 7 has been selected as a result of the discrimination, step S1719 follows. If NO, step S1712 follows.

In step S1712, the application 201 discriminates whether or not the item column 706 in FIG. 7 has been selected on the basis of the event obtained in step S1709. If the item column 706 in FIG. 7 has been selected as a result of the discrimination, the processing routine is finished. If NO, step S1713 follows.

In step S1713, the application 201 discriminates whether or not the setting contents of an arbitrary print condition have been changed on the basis of the event obtained in step S1709. If the setting contents of the arbitrary print condition have been changed as a result of the discrimination, step S1714 follows. If NO, the processing routine is returned to step S1709.

In steps S1715 to S1718, the item columns on the print conditions whose setting orders are lower than the print condition whose setting contents have been changed on the basis of the event obtained in step S1709 are displayed again. For this purpose, in step S1714, the optimum setting order upon the setting of the print conditions obtained in step S1701 is referred to and the orders of the print conditions whose setting orders are one-lower than the print condition whose setting contents have been changed on the basis of the event obtained in step S1709 is obtained and set into the processing counter. For example, when the borderless printing “OFF” is selected in 702 in FIG. 7, it corresponds to the process for displaying again the sheet type whose setting order has been specified to the one-lower order in FIG. 3.

In step S1715, the application 201 discriminates whether or not the value (i) of the processing counter exceeds the total number (N) of print conditions which are set on the print condition setting display screen 700. If it exceeds the total number (N) of print conditions which are set on the print condition setting display screen 700 as a result of the discrimination, the processing routine is returned to step S1709. If it does not exceed the total number, step S1716 follows.

In step S1716, the application 201 obtains the list of the selection items which can be set on the print condition whose setting order (priority) is the same as the value of the processing counter from the user interface driver 203 with reference to the optimum setting order upon the setting of the print conditions obtained in step S1701. In step S1717, the application 201 displays the list of the settable selection items obtained in step S1716 into the item columns arranged in step S1705.

In step S1718, the application 201 increases the value of the processing counter by “1” and returns to step S1715. In step S1719, the application 201 notifies the GDI 202 of the setting contents of the print conditions set on the print condition setting display screen 700, instructs the execution of the printing of the print data, and finishes the processing routine.

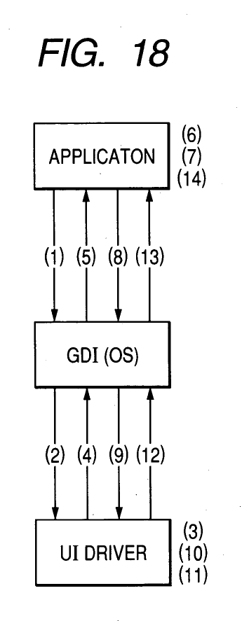

FIG. 18 is a diagram showing an example of a block structure of various drivers and a GDI (OS) showing transmission and reception of information. In FIG. 18, each program corresponds to a module program of the same name as that in FIG. 2. These programs are stored in the hard disk 103 and executed by the host computer (CPU) 101. First, the application 201 inquires the optimum setting order upon the setting of the print conditions through the GDI as shown in (1) and (2) in FIG. 18. As shown in (3) in FIG. 18, the user interface driver searches the setting order information tables in FIG. 3 and obtains the optimum setting order upon the setting of the print conditions. As shown in (4) and (5), the user interface driver notifies the application of the optimum setting order showing the print conditions obtained in (3) through the GDI. As shown in (6), the application displays the print setting condition dialog as shown in FIG. 7 in setting order obtained in (5). In (7), the application waits for an input from the user. When there is an input from the user, as shown in (8) and (9), the application notifies the user interface driver of the print conditions inputted by the user through the GDI. As shown in (10), the application solves conflict of the print conditions whose setting orders are lower than the print condition which was set and inputted by the user. As shown in (11), the user interface driver searches the selection item list information in FIGS. 4 to 6 and determines the selection items which can be selected on the print conditions whose setting orders (priorities) are lower than the print condition which was set and inputted by the user. As shown in (12) and (13), the user interface driver notifies the application of results of (10) and (11) through the GDI. As shown in (14), the item columns of the print conditions whose setting orders are lower than the print condition which was instructed, set, and inputted by the user in (7) are displayed again on the basis of the contents obtained in (13). After that, the processes in (1) to (14) are continued in a layer manner up to the item whose setting order is the lowest.

Explanation will now be supplemented with respect to (6). When the dialog is displayed, the processes to display the item column of each print condition in accordance with the setting order obtained in (5) are necessary. The processes to display the item column of each print condition are the processes of (8), (9), (11), (12), (13), and (14).

As described above, the application 201 obtains the information showing the setting orders of the print conditions as an example of the output conditions regarding the image processes (the setting orders shown in FIG. 3, the priorities showing the setting orders) and obtains candidates of the output conditions retained in the device driver. By using the information showing the setting orders of the output conditions which are related to the image processes and obtained by the application 201, the application 201 further obtains predetermined output conditions from the candidates of the output conditions obtained before.

Before the image is formed by the printer driver (printer graphics driver 206), the application 201 uses the information shown in FIG. 3, that is, confirms that the borderless printing whose setting order. is one-higher than the output condition (sheet type) is “OFF”, and obtains the information shown in 501 in FIG. 5 from the candidates of the output conditions obtained before. When the borderless printing is “ON”, the application 201 obtains the information shown in 502 in FIG. 5. When the information shown in 501 in FIG. 5 is obtained, the application 201 displays the information of 501 as output condition selection candidates. When the information shown in 502 is obtained, the application 201 displays the information of 502 in FIG. 5.

After the application 201 obtains the output conditions, the output conditions whose setting orders are lower than the setting order shown by the information indicative of the setting orders obtained by the application 201 are obtained from a graphics interface driver as an example of the device driver.

The invention is not always limited to the embodiment but can be embodied in various forms. Although a printer driver for driving the printer as an example of the image forming apparatus is preferable as a device driver in the invention, an image processing apparatus such as a digital camera or the like or a peripheral device can be also used.

For instance, although the list of the selection items which can be set on the arbitrary print condition is determined from the selection item list information tables as shown in FIGS. 4 to 6 in the embodiment, a deciding method is not limited to such a method.

Although the print condition setting display screen which the application 201 has is constructed in such a manner that the item columns of the print conditions are arranged and displayed as shown in the print condition setting display screen 700 in FIG. 7 in the embodiment, it can be divided into a plurality of display screens like a Wizard format. The construction of the print condition setting display screen is not limited to such a construction.

### OTHER EMBODIMENTS

The processes shown in FIGS. 15 to 18 in the embodiment are executed by the host computer 101 in accordance with programs which are installed from the outside. In this case, the invention is applied to a case where an information group including the programs are supplied to the host computer by a storing medium such as CD-ROM, flash memory, FD, or the like or from an external storing medium through a network.

Naturally, the object of the invention is accomplished by a method whereby a storing medium in which program codes of software for realizing the functions of the embodiment mentioned above have been recorded is supplied to a system or an apparatus or the program codes are downloaded from an external server (not shown) and a computer (or a CPU or an MPU) of the system or apparatus reads out and executed the program codes stored in the storing medium.

In this case, the program codes themselves read out from the storing medium realize the novel functions of the invention and the storing medium in which the program codes have been stored constructs the invention. As a storing medium for supplying the program codes, for example, a floppy disk, a hard disk, an optical disk, a magnetooptic disk, a DVD, a CD-ROM, a magnetic tape, a non-volatile memory card, a ROM, an EEPROM, or the like can be used.

Naturally, the invention incorporates not only a case where the computer executes the read-out program codes, so that the functions of the embodiment mentioned above are realized but also a case where an OS (Operating System) or the like which is operating on the computer executes a part or all of actual processes on the basis of instructions of the program codes and the functions of the embodiment mentioned above are realized by those processes. Further, naturally, the invention incorporates a case where the program codes read out from the storing medium are written into a memory provided for a function expanding board inserted in the computer or a function expanding unit connected to the computer, thereafter, a CPU or the like provided for the function expanding board or the function expanding unit executes a part or all of actual processes on the basis of instructions of the program codes, and the functions of the embodiment mentioned above are realized by those processes.

This application claims priority from Japanese Patent Application No. 2003-372461 filed Oct. 31, 2003, which is hereby incorporated by reference herein.

1. An information processing apparatus comprising:
a first obtaining unit for obtaining information showing setting orders of output settings regarding an image process and obtaining candidates of output conditions retained in a device driver; and
a second obtaining unit for obtaining a predetermined output condition from the candidates of the output conditions obtained by said first obtaining unit by using the information showing the setting orders of the output settings regarding the image process obtained by said first obtaining unit.

2. An apparatus according to claim 1, wherein said second obtaining unit is installed on the application side and before an image is formed by a printer driver, said second obtaining unit obtains the predetermined output condition from the candidates of said output conditions by using the information showing-said setting orders.

3. An apparatus according to claim 1, further comprising a display control unit for controlling a process to display selection items on a plurality of output conditions which are set on a display screen to set the output conditions held in said application by using the information showing the setting orders obtained by said first obtaining unit.

4. An apparatus according to claim 1, wherein said first obtaining unit is installed on the application side and after said first obtaining unit obtained the output conditions, said first obtaining unit obtains the output conditions whose setting orders are lower than orders shown by the information showing the setting orders obtained by said first obtaining unit from the device driver.

5. An information processing method comprising:
a first obtaining step of obtaining information showing setting orders of output settings regarding an image process and obtaining candidates of output conditions retained in a device driver; and
a second obtaining step of obtaining a predetermined output condition from the candidates of the output conditions obtained by said first obtaining step by using the information showing the setting orders of the output settings regarding the image process obtained by said first obtaining step.

6. A method according to claim 5, wherein said second obtaining step is installed on the application side and in said second obtaining step, before an image is formed by a printer driver, the predetermined output condition is obtained from the candidates of said output conditions by using the information showing said setting orders.

7. A method according to claim 5, further comprising a display control step of controlling a process to display selection items on a plurality of output conditions which are set on a display screen to set the output conditions held in said application by using the information showing the setting orders obtained by said first obtaining step.

8. A method according to claim 5, wherein said first obtaining step is installed on the application side and, in said first obtaining step, after the output conditions were obtained by said first obtaining step, the output conditions whose setting orders are lower than orders shown by the information showing the setting orders obtained by said first obtaining step are obtained from the device driver.

9. An information processing apparatus having a device driver for transmitting and receiving information to/from an application, comprising:
a managing unit for managing output conditions and setting orders corresponding to said output conditions;
an obtaining unit for obtaining an output condition inputted through said application; and
a notifying unit for notifying said application of the output conditions which are managed by said managing unit and has a setting order corresponding to the output condition obtained by said obtaining unit and the setting orders of said output conditions.

10. An information processing method in a device driver for transmitting and receiving information to/from an application, comprising:
a managing step of managing output conditions and setting orders corresponding to said output conditions;
an obtaining step of obtaining an output condition inputted through said application; and
a notifying step of notifying said application of the output conditions which are managed by said managing step and has a setting order corresponding to the output condition obtained by said obtaining step and the setting orders of said output conditions.

11. A control program for allowing a computer to execute:
a first obtaining step of obtaining information showing setting orders of output settings regarding an image process and obtaining candidates of output conditions retained in a device driver; and
a second obtaining step of obtaining a predetermined output condition from the candidates of the output conditions obtained by said first obtaining step by using the information showing the setting orders of the output settings regarding the image process obtained by said first obtaining step.

12. A control program for executing an information processing method in a device driver for transmitting and receiving information to/from an application, wherein said control program allows a computer to execute:
a managing step of managing output conditions and setting orders corresponding to said output conditions;
an obtaining step of obtaining an output condition inputted through said application; and
a notifying step of notifying said application of the output conditions which are managed by said managing step and has a setting order corresponding to the output condition obtained by said obtaining step and the setting orders of said output conditions.
